(19) United States
(12) Patent Application Publication
(10) Pub. No.: US 2015/0208855 A1
(43) Pub. Date: Jul. 30, 2015

(54) FROTH DISPENSERS AND RELATED METHODS

(71) Applicant: David L. J. Jenkins, Portland, OR (US)

(72) Inventor: David L. J. Jenkins, Portland, OR (US)

(21) Appl. No.: 14/599,936

(22) Filed: Jan. 19, 2015

Related U.S. Application Data
(60) Provisional application No. 61/931,488, filed on Jan. 24, 2014.

(51) Int. Cl. A47J 31/44; A23C 9/152; B01F 3/04; A47J 31/46

(52) U.S. Cl. CPC A47J 31/4496; A47J 31/46; A23C 9/1524; B01F 3/04808; B01F 3/04439; B01F 3/04453; B01F 2003/04943; B01F 2215/0006

(57) ABSTRACT

Froth dispensers and related methods are disclosed. Presently disclosed froth dispensers may be handheld and hand-operated, without requiring the use of batteries or electricity. Said froth dispensers may be used to froth (e.g., produce a soft, airy, foam from) any liquid, such as milk or cream, for any purpose, such as for topping drinks or foods. Disclosed froth dispensers may be used to froth just a portion of the liquid stored in the dispenser's reservoir, and may be stored, such as in a refrigerator, between uses, thereby not requiring cleaning after each use. Disclosed froth dispensers may be used with one or more packets of materials that can enhance the froth and/or impart a flavor to the froth. Froth may be dispensed from the froth dispensers by, for example, manually depressing a pump head, which in turn may cause foam to be dispensed from the froth dispenser.

### FIELD

The present disclosure relates to froth dispensers and related methods.

### BACKGROUND

Froth is an aerated liquid that can create a light, soft, foam. Coffee drinks, such as lattes, cappuccinos, mochas, etc. are often accompanied by a light, creamy topping made of milk froth. Professional baristas and coffee shops use expensive machines that create froth using a manual process and steam. Consumer options for producing froth at home or work include a variety of handheld devices and counter-top appliances.

For example, a variety of electric steamers have been used to foam or froth milk. Prior art foaming devices are typically complicated machines which involve the use of steam to aerate or foam the milk. Most of these devices involve at least a steam generator, which provides superheated steam, and an air channel, which provides air flow. The steam and air are mixed in pipes, and output through a single tube, which is normally positioned to be placed into a container of milk. When the steam and air are discharged from the tube into the milk, the frothing process begins. After a time, the steam and air froth the milk to the desired consistency, and the user is able to use the frothed milk. Such prior art appliances are often large and unwieldy, possessing a number of tubes or pipes through which the pressurized steam is injected into the milk. These devices are also expensive and take up a significant amount of counter or storage space. These devices also require an energy source and cleaning after each use.

Handheld battery-operated frothers also exist. Such frothers typically consist of a wand or rod that is inserted into the milk, and that includes a vibrating or moving whisk, disk, or spring at the base of the rod. For example, U.S. Pat. No. 6,558,035 (Lane) discloses a handheld battery-operated electric whisk designed for frothing milk for use in specialty coffees. Such handheld battery-operated frothers disadvantageously require batteries and cleaning after each use. Further, these devices froth the entire volume of liquid in the container, which can be wasteful if one does not use the entire volume of froth within the shelf life of the froth, which is usually around 10-20 minutes.

A variety of manually-operated frothing devices also exist for frothing a liquid inside a container, typically utilizing a screen or mesh disc that is moved vertically (e.g., axially along the height of the container) and repeatedly through the liquid to form the froth desired. For example, U.S. Pat. No. 5,780,087 (Brady) discloses an apparatus and method for frothing liquids that includes a container and a rod which extends vertically through the container's lid and terminates in a plunger device which is used to rapidly pump and agitate the liquid in the container to accomplish the frothing of the liquid. Similarly, U.S. Pat. No. 7,416,327 (Ghidini) discloses a foaming device for the preparation of coffee and milk drinks that is designed to be applied to coffee mugs of various sizes by including a cover with concentric annular grooves that closes the top of the coffee mug when placed on top. The foaming device of Ghidini includes a rod having a knob protruding from the cover, the knob being used to move a disk fastened to the lower end of the rod repeatedly, such that mesh windows in the disk cause air particles to remain imprisoned in the drink and allow formation of a persistent cream or foam. Such manually-operated devices can require extended sessions of agitating or pumping the frother to produce the desired froth, such as many which require 30 seconds or longer of manual action to produce a desired froth. Further, the mesh disks and plungers of such devices can be difficult to clean sufficiently. Finally, like the battery-operated handheld devices, the manually-operated pumping frothers also produce froth from the entire volume of milk in the container, which can be disadvantageous and wasteful.

Conventional electric frothing devices are large, expensive, require electricity, and require monitoring and/or cleaning after each use. Conventional manually-operated frothing devices require cleaning after each use and also require repeated pumping or agitation of the plunger or mesh disk through the liquid being frothed, which can be tedious and/or difficult to perform long enough to create the desired froth or foam. Conventional battery-operated frothers require the use of batteries and cleaning after each use. There thus remains a need for an improved device for producing froth and a method for frothing liquids that addresses or at least partially alleviates one or more disadvantages in the prior art.

### SUMMARY

A froth dispenser is presently disclosed that may be configured to deliver aeration to a liquid to create froth. One or more aerators may be incorporated into a handheld, hand-operated froth dispenser in order to produce froth from a liquid (e.g., milk), where the resulting froth may be thick, creamy, light, soft, and/or foamy. Such presently disclosed froth dispensers may enable production of froth from a liquid without requiring batteries, electricity, or cleansing after each use. Furthermore, presently disclosed froth dispensers may be configured to froth a portion of a volume of liquid at a time, rather than the entire volume of liquid.

Certain embodiments of a froth dispenser can produce froth from a liquid, such as milk, without the need for repeated pumping or agitation of the liquid. For example, one embodiment of a froth dispenser can dispense froth with a single depression of a hand-actuated pump associated with the froth dispenser. In this manner, froth may be produced and dispensed rapidly (e.g., within 1-2 seconds or less). Disclosed froth dispensers may be stored in a chilled environment, such as a refrigerator, with a reservoir of liquid stored in the dispenser between uses. Presently disclosed froth dispensers can be configured to froth a small quantity of liquid at a time (e.g., a portion of the liquid within the reservoir), as opposed to the described prior art frothing devices, which tend to froth the entire quantity of liquid exposed to the frothing device. For example, each time a hand pump is depressed on the present froth dispensers, a small volume of froth may be produced, leaving a remaining volume of liquid in the dispenser reservoir that is not frothed. Some embodiments of a froth dispenser according to the present disclosure need not be cleaned after each use and are reusable a plurality of times without needing maintenance or other intervention. The liquid in the froth dispenser reservoir can be removed and replaced with a different liquid if a different liquid is desired, and/or when the existing liquid needs replacing (e.g., due to age, or depletion of the volume of liquid in the reservoir).

Disclosed embodiments of a froth dispenser may be used with a variety of liquids or fluids that may be capable of producing froth (e.g., “foamable liquids”). Examples of suitable liquids include milk (e.g., low-fat milk, skim milk, whole milk, 2% milk), cream, a milk substitute (e.g., soy milk, almond milk, rice milk, hemp milk, coconut milk), reconstituted evaporated milk, powdered milk, reconstituted powdered milk, goat's milk, creamer, condensed milk, egg whites, alcohol, and/or beer, and may be added as a topping or other additive to any drink or food.

Also disclosed are packets that may be mixed with the liquid in the reservoir of a froth dispenser, such packets being functional to, for example, impart a flavor and/or affect the texture of the froth (e.g., packets may be mixed with the liquid in the reservoir to enhance the creaminess and/or frothiness of the foam or froth produced by the dispenser). In some embodiments, a froth dispenser may include one or more of such packets. For example, a kit may include a froth dispenser and one or more packets. The packets may be opened and poured into the dispenser reservoir, and mixed with liquid existing in the dispenser reservoir or liquid that is subsequently added. In some embodiments, the packets may simply be dropped into the reservoir and/or into the liquid in the reservoir, and be dissolved into or mixed with the liquid in the reservoir. The packets may include packet contents that are a solid form (e.g., capsules, tablets, pellets, or a block), powder, and/or liquid that may be mixed with a foamable liquid in the dispenser reservoir.

Also disclosed are methods of producing froth from a liquid, such as milk, and methods of using disclosed froth dispensers. For example, a froth dispenser may be provided and a quantity of foamable liquid may be added to the reservoir of the froth dispenser. In some examples, the liquid may be a milk or cream product, and the froth produced may be milk froth, such as for topping a coffee drink (e.g., cappuccinos or lattes). Additionally or alternatively, the froth may be dispensed onto any suitable beverage or food, such as hot chocolate, alcoholic drinks, cocktails, fruit, dessert, vegetables, pudding, oatmeal, cereal, waffles, yogurt, ice cream, pancakes, crepes, hot breakfast cereal, potatoes, French fries, coffee beverages, hot alcoholic beverages, etc. The produced froth also may be used as an additive or mix-in with beverages (e.g., cocktails or coffee drinks) and/or food items.

Manually pressing a dispenser head (also referred to herein as an actuator) in a generally downward direction (e.g., towards the reservoir of the froth dispenser) may cause mixing of the liquid in the reservoir and air, thereby producing a foam or a froth that is dispensed through the outlet. In some methods, one or more packets may be opened and poured into the liquid in the reservoir before the froth is dispensed. Such packets may be formulated to impart a flavor to the liquid and resulting froth, and/or may enhance the frothing action of the froth dispenser. Example flavors that may be imparted by said packets include mocha, marshmallow, caramel, salted caramel, vanilla, chocolate, lemon, ranch, etc.

Business methods of selling and distributing disclosed froth dispensers and related packets and/or aerators also are disclosed. For example, a froth dispenser may be sold as a kit, together with one or more packets. In some methods, for example, a multi-use froth dispenser may be sold to a consumer and reused over and over again, with different liquids and/or different packets. In some methods, a froth dispenser may be sold together with one or more packets. For example, a froth dispenser may be sold together with a collection of 2 or more packets (e.g., 6 or 10 packets), the packets being either an assortment of different packets, or a collection of 6 or 10 of the same packet. Additionally or alternatively, the packets may be sold separately from the froth dispenser. Froth dispenser kits also may include instructions for using the froth dispensers of the present disclosure to froth a dairy product (e.g., instructions for frothing milk for a coffee beverage) and/or one or more aerators specifically configured for different types of liquids. Additionally or alternatively, replacement aerators and/or specialized aerators also may be sold separately from the froth dispenser kits.

### BRIEF DESCRIPTION OF THE DRAWINGS

FIG. 1 is a schematic block diagram representing froth dispensers according to the present disclosure.

FIG. 2 is a side elevation view of an example of a froth dispenser according to the present disclosure, with some structures shown in cross-section.

FIG. 3 is a block diagram representing methods of using froth dispensers according to the present disclosure.

FIG. 4 is a block diagram representing methods of selling froth dispensers and one or more packets according to the present disclosure.

### DESCRIPTION

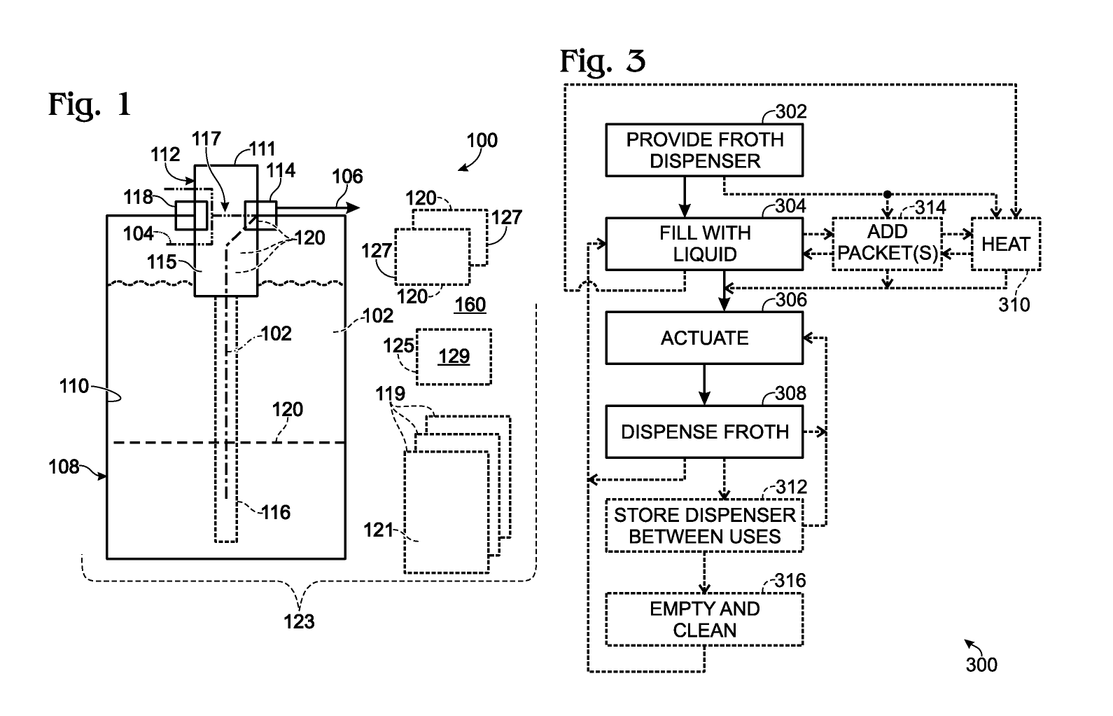

FIG. 1 shows a schematic block diagram of a froth dispenser 100 according to the present disclosure. A liquid 102 may be added to and/or stored inside the froth dispenser 100, and upon actuation of the froth dispenser 100, the liquid 102 may be combined with air 104 to form a froth 106 that is output from the froth dispenser 100. In some examples, the liquid 102 may be a dairy liquid, such as milk, and the froth 106 may be milk froth, such as for dispensing onto a coffee beverage. In these examples, the froth dispenser 100 may be specifically configured to form a dairy froth.

Liquid 102 may include one or more of milk, cream, creamer, half and half, low-fat milk, whole milk, skim milk, 2% milk, egg whites, alcohol, beer, goat's milk, soy milk, rice milk, almond milk, hemp milk, coconut milk, a milk substitute, condensed milk, powdered milk, water, yogurt, cream fraiche, reconstituted powdered milk, evaporated milk, and reconstituted evaporated milk. The froth 106 may be dispensed from the froth dispenser 100 onto and/or mixed into any beverage or food item, such as coffee, coffee beverages (e.g., iced coffee beverages, lattes, cappuccinos, mochas, Americanos, espressos, etc.), hot chocolate, alcoholic drinks, including hot alcoholic beverages, alcohol, cocktails, fruit, dessert, vegetables, pudding, oatmeal, cereal, waffles, yogurt, ice cream, pancakes, crepes, hot breakfast cereal, potatoes, French fries, etc.

Froth dispenser 100 may include a froth dispenser container 108, the interior walls of which can define a dispenser reservoir 110 that is configured to receive and hold a volume of liquid 102 (which may be referred to herein as foamable liquid 102) within dispenser reservoir 110. The froth dispenser container 108 may be, for example, a plastic container made of any suitable polymer (e.g., polypropylene), a glass container, a steel container, a ceramic container, or a container of any non-reactive material suitable to hold a volume of liquid 102. Froth dispenser container 108 may take any shape. Suitable, non-limiting examples include substantially cylindrical, substantially spherical, conical, tapered, contoured, pyramidal, and/or undulating with portions of varying diameter along the height of the container. Froth dispenser container 108 may be flexible or rigid or somewhere in between. In some examples, froth dispenser container 108 may include one or more rigid portions, one or more semi-rigid portions, and/or one or more flexible portions. Froth dispenser container 108 may be sized to hold any volume of foamable liquid 102. In some examples, froth dispenser container 108 may be sized to hold at least 1 tablespoon, at least ¼ cup, at least ½ cup, at least 1 cup, at least 2 cups, at least 3 cups, at least 4 cups, and/or at least 6 cups or more of foamable liquid 102 (or at least 10 mL, at least 50 mL, at least 100 mL, at least 200 mL, at least 500 mL, at least 1,000 mL, and/or at least 1,500 mL or more of foamable liquid 102).

Actuation of froth dispenser 100 may cause a portion of liquid 102 (e.g., a dispensed volume) in dispenser reservoir 110 to be frothed, while leaving a remaining portion of liquid 102 in dispenser reservoir 110 unfrothed, for subsequent actuations and uses. Remaining portions of liquid 102 may be contained in dispenser reservoir 110 between uses of froth dispenser 100, and may be stored in dispenser reservoir 110 while the froth dispenser is not in use. In this manner, froth dispenser 100 may be configured to be used a plurality of times and likewise may be used a plurality of times without needing to be cleaned between uses (e.g., froth dispenser 100 may be used a plurality of times without needing to change or add to liquid 102 in dispenser reservoir 110 between uses). In some examples, substantially the entire volume of liquid 102 in dispenser reservoir 110 eventually may be frothed and output as froth 106 from froth dispenser 100 (e.g., by actuating froth dispenser 100 a plurality of times spaced through a period of time ranging from a few seconds to a few weeks or more), and then froth dispenser container 108 may be cleaned, and/or a new liquid 102 may be placed in dispenser reservoir 110 for future uses. If desired, froth dispenser 100 may be emptied and/or cleaned before all of a particular liquid 102 in dispenser reservoir 110 is frothed (e.g., any remaining liquid 102 in the dispenser reservoir 110 may be poured out at any point, after any number of uses of froth dispenser 100, to allow cleaning of froth dispenser container 108), and a different liquid 102 may be placed in dispenser reservoir 110.

Froth dispenser container 108 may be sized to comfortably be held in one hand of a user. In some examples, froth dispenser container 108 may be sized to be compact and not take up significant amounts of counter space or storage space. Froth dispenser container 108 may be sized to be small enough to fit within a typical residential refrigerator and/or within a typical residential microwave. Froth dispenser 100 also may be large enough that dispenser reservoir 110 holds a volume of liquid 102 sufficient to produce a plurality of dispensed volumes of froth 106 for topping and/or adding to a plurality of foods and/or beverages. For example, dispenser reservoir 110 may be large enough to hold a volume of liquid 102 that is sufficient enough that froth dispenser 100 may be actuated a plurality of times, thereby producing a plurality of dispensed volumes of froth 106 without emptying the volume of liquid 102 stored in dispenser reservoir 110. For example, dispenser reservoir 110 may be sized to hold a volume of liquid 102 that would allow for froth dispenser 100 to be actuated between 1 and 5,000 or more times (thereby dispensing between 1 and 5,000 dispensed volumes of froth 106) without emptying the volume of liquid 102 in dispenser reservoir 110.

In some examples, froth dispenser 100 may be actuated between 1 and 10 times to produce a suitable volume of froth 106 to top or mix into a given beverage or food item. Each actuation and dispensing of the dispensed volume of froth 106 may take just 1-2 seconds or less in some examples, thereby essentially simultaneously and instantly producing froth 106. In one specific example, froth dispenser 100 may contain about 1,000 mL of foamable liquid 102 in dispenser reservoir 110, and each time froth dispenser 100 is actuated, a dispensed volume of less than 1 mL of the liquid 102 is frothed and output as a froth 106, the froth having between 1 and 100 times or more of the original dispensed volume of the liquid 102, due to aeration of the foamable liquid 102. In this example, froth dispenser 100 may be actuated 1,000 times or more (although generally, just one actuation or a few actuations may be sufficient to produce the desired froth topping or addition for a food item or beverage) without requiring additional liquid 102 to be added to froth dispenser 100, and each time froth dispenser 100 is actuated, a volume of froth between about 1 mL and 100 mL may be output.

Froth dispenser 100 may be actuated by manipulating an actuator 112. For example, actuator 112 may be a manually-operated hand pump that is pressed down by a user each time froth dispenser 100 is desired to be actuated (e.g., each time a user desires to dispense more froth 106). Actuator 112 may include a user engagement portion 111 that optionally may be ergonomically shaped to optimize comfort for a user actuating (e.g., pressing) actuator 112. Actuator 112 may be configured such that pressing downward on actuator 112 moves actuator 112 into a depressed position, and actuator 112 may be biased to return to a resting upward position upon release of actuator 112 (e.g., when a user removes his or her hand from user engagement portion 111 of actuator 112, thereby removing any force applied to actuator 112, actuator 112 may automatically return to its resting, upward position). As shown in FIG. 1, a portion of actuator 112 may be positioned outside froth dispenser container 108 (e.g., user engagement portion 111) and a portion 115 of actuator 112 may extend into froth dispenser container 108 and/or into liquid 102.

Pressing down on the actuator 112 may cause froth 106 to exit the froth dispenser 100 at a dispenser outlet 114 essentially simultaneously with the depressing of actuator 112 (e.g., froth 106 may be dispensed as actuator 112 is being pressed down, and may be completed being dispensed by the time actuator 112 is pressed down as far as it will go, typically being limited in range by a portion of actuator 112 colliding with a closure 118, which may be positioned at or near the top of the froth dispenser container 108).

Actuator 112 may be slidably engaged with closure 118, such that during actuation, actuator 112 slides up and down with respect to the closure 118. Closure 118 may provide a removable coupling mechanism that removably secures actuator 112 to froth dispenser container 108 via a coupling mechanism, or structure. For example, closure 118 may include a snap-fit mechanism that snaps onto a portion of froth dispenser container 108, a friction-fit engagement with froth dispenser container 108, and/or corresponding threads (e.g., internal threads on an inner surface of the closure 118 that are configured to engage with external threads on an outer surface of froth dispenser container 108) such that the closure 118 may be screwed onto froth dispenser container 108 during use and removed to facilitate cleaning of froth dispenser 100 and/or adding liquid 102 to froth dispenser container 108. Closure 118 and/or actuator 112 may be configured to cover an opening 117 in froth dispenser container 108, such that liquid 102 within dispenser reservoir 110 may not exit through opening 117 when closure 118 and/or actuator 112 are secured to froth dispenser container 108. When closure 118 and/or actuator 112 are removed from froth dispenser container 108, opening 117 may be exposed, providing an entry for adding liquid to dispenser reservoir 110.

As schematically represented in FIG. 1 in dash-dot-dot lines, air 104 may be mixed with, or otherwise combined with, liquid 102 to form froth 106 in response to actuation of actuator 112. In some embodiments, air 104 may be drawn from within froth dispenser container 108 to be mixed with liquid 102. Additionally or alternatively, in some embodiments, air 104 may be drawn from external to the container, as shown in FIG. 1.

A dip tube, or straw, 116 optionally may be positioned within froth dispenser container 108, with at least a portion of the dip tube 116 being in contact with a volume of liquid 102 in dispenser reservoir 110. When actuator 112 is actuated, a volume of liquid 102 may be drawn from dispenser reservoir 110, optionally through dip tube 116 (shown in dash-dot lines), and mixed with air 104 (e.g., aerated) to form froth 106. Mixing of air 104 and liquid 102 may occur within dispenser reservoir 110, within dip tube 116, within actuator 112, and/or within dispenser outlet 114. One or more aerators 120 may be provided in froth dispenser 100 (e.g., within dispenser reservoir 110, within dip tube 116, within actuator 112, and/or within dispenser outlet 114) to enhance froth production. Froth 106 then may be essentially simultaneously dispensed via dispenser outlet 114. As shown in FIG. 1, dispenser outlet 114 may be formed from a part of actuator 112, a part of closure 118, and/or a part of froth dispenser container 108.

Froth dispenser 100 may be configurable between one or more configurations to optimize the froth dispenser 100 for different liquids 102. For example, a first configuration may correspond to the froth dispenser 100 being optimized for a first liquid in dispenser reservoir 110, while a second configuration may correspond to the froth dispenser 100 being optimized for a second liquid in the dispenser reservoir 110, the first liquid being different from the second liquid. The first and second liquids can be, for example, different types of dairy products. For example, the froth dispenser 100 may have different configurations based on whether the liquid 102 in the dispenser reservoir 110 is a low-fat liquid (e.g., low-fat milk or skim milk) or a high-fat liquid (e.g., whole milk or cream). In some embodiments, changing froth dispenser 100 from one configuration to another can include changing, adding, and/or reducing the type and/or number of aerators 120 in froth dispenser 100. For example, different types of aerators 120 may be provided for use with different types of liquids (e.g., froth dispenser 100 may include one or more aerators 120 optimized for low-fat liquids, one or more aerators 120 optimized for high-fat liquids, one or more aerators 120 optimized for milk-substitutes, one or more aerators 120 optimized for non-milk liquids, etc.). Additionally or alternatively, the number of aerators 120 can be increased or decreased in different configurations of froth dispenser 100, depending on the type of liquid 102 used and/or depending on the desired amount of frothiness of the produced froth 106. One or more aerators 120 may be mesh aerators, such as mesh aerators having a mesh size configured to froth a dairy product such as milk. Illustrative, non-exclusive examples of mesh sizes that may be incorporated into one or more aerators 120 include (but are not limited to) mesh sizes in the ranges of 0.1-5 millimeters (mm), 0.1-3 mm, 0.1-1 mm, 0.5-5 mm, 0.5-3 mm, 0.5-1 mm, 1-5 mm, 1-3 mm, and 3-5 mm.

One or more packets 119 containing packet contents 121 may be provided for use with froth dispenser 100. Such packet contents 121 may be configured to alter and/or improve one or more qualities of liquid 102 and/or resulting froth 106 (e.g., taste, flavor, color, appearance, mouth feel, volume, degree of aeration, viscosity, degree of frothing, thickness, and/or useful life, etc.). Froth dispenser 100 may be sold as a kit 123 that includes both froth dispenser 100 and one or more packets 119. Additionally or alternatively, kit 123 may include one or more aerators 127 (which may be examples of aerators 120) and/or instructions 125 for using froth dispenser 100.

Packets 119 may be individually sized, such that a single packet 119 contains an appropriate amount of packet contents 121 such that the entire packet contents 121 in a single packet 119 may be added to dispenser reservoir 110 and mixed with liquid 102. In other examples, a single packet 119 may contain an amount of packet contents 121 sufficient for a larger volume of liquid than is contained in froth dispenser 100. In such examples, a portion of packet contents 121 may be added to dispenser reservoir 110 and mixed with liquid 102. For example, a packet 119 may be opened, and some or all of packet contents 121 within packet 119 may be poured into froth dispenser container 108 via opening 117. Packet contents 121 may be formulated to impart a flavor to and/or increase frothiness of froth 106 dispensed from froth dispenser 100. Packet contents 121 may include one or more ingredients, such as powders, stabilizers, thickening agents, emulsifiers, gelling agents, masking agents, and/or any other additive. In some examples, packet contents 121 may include agar, lecithin, gelatin, natural fats, xanthan gum, sugar, pectin, starch, guar gum, gum arabic (acacia gum), konjac, methylcellulose, locust bean gum, tara gum, carrageenan, yucca extract powder, quillaja extract powder, and/or any other desired ingredient. Examples of suitable ingredients for packet contents 121 may be obtained from any source, such as from TIC Gums, Inc. (White Marsh, Md.). Additionally or alternatively, one or more of such ingredients may be added to froth dispenser container 108 from a bulk quantity of such ingredients without using packets 119.

Aerators 127 may be included in kit 123 separate from aerators 120 that may come assembled within or included within froth dispenser 100. Aerators 127 may be provided and configured to be interchangeable with aerators 120 (e.g., aerators 127 may be selectively used with froth dispenser 100). For example, one or more aerators 120 may be selectively removable from froth dispenser 100 and selectively replaced with one or more aerators 127. In some examples, different respective aerators 127 may be configured for different types of liquids. For example, a first respective aerator 127 may be configured for frothing a full fat liquid (e.g., cream or whole milk), while a second respective aerator 127 may be configured for frothing a reduced-fat or fat free liquid (e.g., skim milk or 2% milk). In this manner, kit 123 may include a plurality of aerators 120 and/or aerators 127 that may be used with froth dispenser 100 to froth a liquid, where froth dispenser 100 may be customizable for use with different liquids, such as by customizing which respective aerator or aerators 120, 127 are used, depending on the desired application.

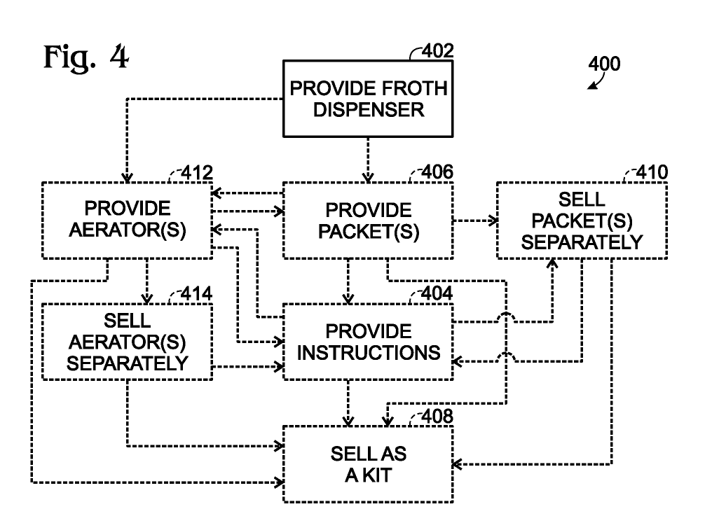

Instructions 125 may be included in kit 123, having indicia 129 regarding use of froth dispenser 100. For example, instructions 125 may include written and/or illustrated indicia 129 that instruct and/or show a user how to use the froth dispenser to froth at least one of: milk, cream, creamer, half and half, low-fat milk, whole milk, skim milk, 2% milk, egg whites, alcohol, beer, goat's milk, soy milk, rice milk, almond milk, hemp milk, coconut milk, a milk substitute, condensed milk, powdered milk, water, yogurt, cream fraiche, reconstituted powdered milk, evaporated milk, and reconstituted evaporated milk. In some examples, instructions 125 may include written and/or illustrated indicia 129 instructing and/or showing a user how to perform one or more steps of any of the methods of FIGS. 3-4, described below.

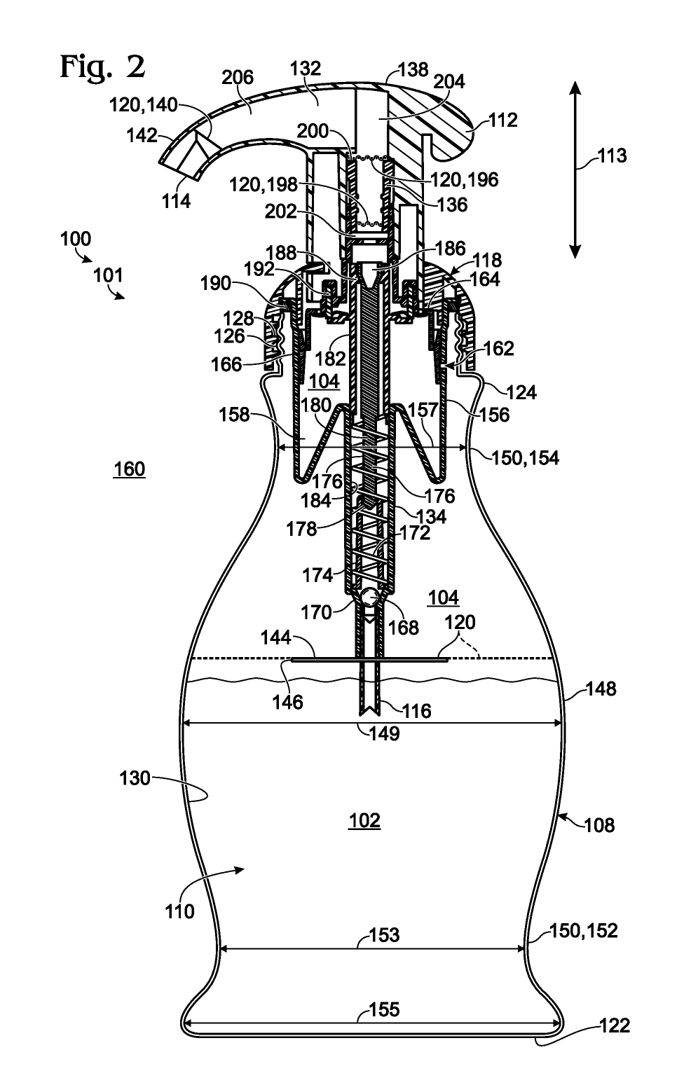

Turning now to FIGS. 2-4, illustrative non-exclusive examples of froth dispensers and associated methods are illustrated. Where appropriate, the reference numerals from the schematic illustration of FIG. 1 are used to designate corresponding parts of the froth dispenser of FIG. 2 and also may be referenced to provide context for the methods of FIGS. 3-4. However, the example of FIG. 2 is non-exclusive, and froth dispensers are not limited to the illustrated embodiment. For example, the froth dispenser of FIG. 2 may incorporate any number of the various aspects, configurations, characteristics, properties, etc. that are illustrated in and discussed with reference to the schematic representations of FIG. 1, as well as variations thereof, without requiring the inclusion of all such aspects, configurations, characteristics, properties, etc. Likewise, the examples of FIGS. 3-4 are non-exclusive, and the methods are not limited to the illustrated embodiments. For the purpose of brevity, each previously discussed component, part, portion, aspect, region, etc. or variants thereof may not be discussed, illustrated, and/or labeled again with respect to each embodiment, however, it is within the scope of the present disclosure that the discussed features, variants, etc. may be utilized with each embodiment.

FIG. 2 shows a side elevation view of a froth dispenser 101 according to the present disclosure, with most structures shown in cross-section. Froth dispenser 101 is an illustrative, non-exclusive example of froth dispenser 100 of FIG. 1, and generally includes a froth dispenser container 108 that defines a dispenser reservoir 110 (e.g., an inner wall 130 of the froth dispenser container 108 can define the dispenser reservoir 110), which is configured to receive and hold a volume of liquid 102 (e.g., milk).

At least a portion of dip tube 116 may be positioned to extend into dispenser reservoir 110, and likewise into a volume of liquid 102 contained in dispenser reservoir 110. Froth dispenser 101 may include an actuator 112 that is removably secured to froth dispenser container 108, such as via a closure 118, actuator 112 providing an internal passage 132 leading to the dispenser outlet 114, an opening through which the froth is dispensed (e.g., where the froth exits froth dispenser 101). Actuator 112 may be slidably engaged with closure 118 such that actuator 112 may move up and down in the directions indicated by arrow 113 with respect to closure 118, and actuator 112 may be configured such that ambient air 160 from outside froth dispenser 101 can pass between actuator 112 and closure 118 (e.g., at the interface along which the actuator 112 slides within the closure 118).

Froth dispenser container 108 may have a base 122 and an upper portion 124 opposite base 122; base 122 generally providing a flat surface on which froth dispenser 101 can rest when placed on a surface such as a table, counter, a surface inside a microwave, and/or a surface inside a refrigerator. Base 122 may be configured to provide a stable foundation for froth dispenser 101, generally resisting tipping of froth dispenser 101 and/or keeping froth dispenser 101 generally level when placed on a substantially flat surface. Closure 118 may be removably coupled to upper portion 124 of froth dispenser container 108, such as being screwed onto froth dispenser container 108 with internal threads 128 on an inner surface of the closure 118 that engage with external threads 126 on an outer surface of the froth dispenser container 108, adjacent the upper portion 124.

FIG. 2 shows actuator 112 in a resting, upward position, which is the position the froth dispenser rests in when actuator 112 is not being depressed (e.g., when there is no external force applied downwardly on actuator 112). Actuator 112 may be configured, upon actuation of actuator 112 by depressing actuator 112 (e.g., a manually-operated pump head) to a depressed position, to cause formation of a froth formed from a mixture of air 104 and liquid 102 in dispenser reservoir 110. Actuator 112 may include an upper convex portion 138 that is curved and configured to increase comfort for a user during actuation. As shown in FIG. 2, dispenser outlet 114 may be a downward facing opening 114 formed integrally with actuator 112. The downward facing dispenser outlet 114 may aid in directing the froth being dispensed such that it is dispensed in the general area of desire.

With each actuation, a portion of liquid 102 corresponding to a dispensed volume can move through froth dispenser 101, leaving a remaining volume of liquid 102 in dispenser reservoir 110, the dispensed volume following a fluid path defined by structures of froth dispenser 101. For example, a fluid path can lead from dispenser reservoir 110 to the dispenser outlet 114 and can be defined at least in part by dispenser reservoir 110, dip tube 116, a liquid conduit 134, an aerator chamber 136, and dispenser outlet 114.

Froth dispenser 101 may include one or more aerators 120 positioned at various locations throughout froth dispenser 101. An outlet aerator 140 (which is an example of aerator 120) may be positioned adjacent dispenser outlet 114 in actuator 112. In some embodiments, actuator 112 may include a hinge adjacent dispenser outlet 114, wherein the hinge may be configured to allow a hinged portion 142 of dispenser outlet 114 to move from a first position wherein hinged portion 142 is in contact with the rest of actuator 112 (as shown in FIG. 2) to a second position wherein hinged portion 142 is flipped up, away from the rest of actuator 112, and or to a range of hinge positions there between. In this example, in the first position, outlet aerator 140 is in the fluid path of the froth exiting dispenser outlet 114, and in the second position, outlet aerator 140 is not in the fluid path of the froth exiting dispenser outlet 114.

Froth dispenser 101 may include additional and/or alternative aerators 120, such as a reservoir aerator 144 positioned within dispenser reservoir 110. In some examples, reservoir aerator 144 may be positioned adjacent dip tube 116. As with any aerator 120, reservoir aerator 144 may be, for example, a plastic or polymeric mesh aerator, a metallic mesh aerator, a ceramic mesh aerator, and/or a composite mesh aerator. As seen in FIG. 2, reservoir aerator 144 may be oriented substantially parallel to base 122 of froth dispenser container 108 and may extend radially from dip tube 116 towards inner wall 130 of froth dispenser container 108. In some embodiments, reservoir aerator 144 extends only part of a radial distance from dip tube 116 towards inner wall 130 (as in FIG. 2), thereby leaving a gap between a circumferential edge 146 of reservoir aerator 144 and inner wall 130 of froth dispenser container 108. In other embodiments, reservoir aerator 144 may extend radially from dip tube 116 all the way to inner wall 130 of froth dispenser container 108, so that circumferential edge 146 of reservoir aerator 144 contacts or is in close proximity to inner wall 130 of froth dispenser container 108, as schematically illustrated in dashed lines. Circumferential edge 146 of reservoir aerator 144 may form a gasket-like seal with inner wall 130 of froth dispenser container 108. Circumferential edge 146 of reservoir aerator 144 may be flexible or rigid and/or may be formed of a different material than the other portions of reservoir aerator 144. At least a portion of reservoir aerator 144 may be flexible to facilitate insertion and removal of mesh aerator 144 through the opening at the upper portion 124 of froth dispenser container 108. Reservoir aerator 144 may include more than one aerator 144 positioned within dispenser reservoir 110.

As shown in FIG. 2, froth dispenser container 108 may be contoured, such that a wider portion 148 has a larger diameter (e.g., maximum diameter 149) than one or more narrower portions 150, such as narrow portion 152 adjacent base 122 having first diameter 153 or narrow portion 154 adjacent upper portion 124 having second diameter 157. In some examples, the maximum diameter 149 of wider portion 148 may be approximately equal to base diameter 155 of base 122, although other configurations are also possible. For example, the base diameter 155 of base 122 may be greater than the maximum diameter 149 of wider portion 148, or the base diameter 155 of base 122 may be less than the maximum diameter 149 of wider portion 148.

Froth dispenser 101 may include a housing 156 that is positioned inside froth dispenser container 108 when actuator 112 is secured on froth dispenser container 108. Housing 156 may define an air chamber 158 configured to hold a volume of air 104. Air chamber 158 may be in fluid communication with ambient air 160 outside of froth dispenser 101 when froth dispenser 101 is in some configurations, such as when the froth dispenser is in the depressed position. In some examples, air chamber 158 is not in fluid communication with ambient air 160 outside of froth dispenser 101 when actuator 112 of froth dispenser 101 is in the upward position shown in FIG. 2. Housing 156 may include one or more side vent openings 162 that may allow passage of air into air chamber 158 in some configurations. For example, an air piston 164 may have an air chamber scraper 166 that covers the side vent opening 162 when froth dispenser 101 is in the upward, resting position, so that ambient air 160 cannot pass into air chamber 158. When actuator 112 is actuated and froth dispenser 101 is in the depressed position, air piston 164 may be moved downward towards base 122 of froth dispenser container 108 such that air chamber scrapers 166 do not cover side vent opening 162, thereby allowing passage of ambient air 160 from outside froth dispenser 101, into froth dispenser 101, and through side vent opening 162 (e.g., into air chamber 158). Froth dispenser 101 may include a single side vent opening 162, or may include two or more side vent openings 162 spaced about the circumference of housing 156, with each side vent opening having a corresponding air chamber scraper 166 to selectively block or uncover side vent opening 162 depending on positioning of actuator 112.

Dip tube 116 may be in fluid communication with liquid conduit 134 while froth dispenser 101 is in the depressed position and/or in the upward position. In some embodiments, a lower check valve 168 (e.g., a polymeric, metallic, and/or glass check valve) positioned within or near a lower valve seat 170 can control whether liquid 102 can pass from dip tube 116 into liquid conduit 134. In one specific example, lower check valve 168 may be a glass ball check valve. Lower valve seat 170 may be formed by an interface between liquid conduit 134 and dip tube 116, such that when lower check valve 168 is engaged within lower valve seat 170, fluid is substantially prevented from flowing upwards from dip tube 116 into liquid conduit 134, and when lower check valve 168 is not engaged within lower valve seat 170, fluid is allowed to pass through the lower valve seat 170 such that it can flow from dip tube 116 up into liquid conduit 134.

A spring 172 (e.g., a stainless steel spring) positioned within liquid conduit 134 may force lower check valve 168 into lower valve seat 170 when froth dispenser 101 is in the depressed position, thereby blocking passage of liquid 102 from dip tube 116 into liquid conduit 134. In the upward position, a force applied by spring 172 on lower check valve 168 may be low enough (or zero) such that lower check valve 168 is not pressed into lower valve seat 170, thereby allowing liquid 102 to pass from dip tube 116, through lower valve seat 170, around lower check valve 168, and into liquid conduit 134.

Froth dispenser 101 also may include a spring stem 174 positioned within the lower end of spring 172 to hold it in place, as well as a pull stick 176, the lower end of which travels vertically within the spring stem during operation of the dispenser. An enlarged portion 178 of pull stick 176 may be configured to engage with spring stem 174, and a narrow portion 180 of pull stick 176 may be positioned within liquid conduit 134.

A liquid piston 182 may be slidably engaged with an interior wall 184 of liquid conduit 134 and an upper check valve 186 may be positioned within the fluid path between liquid conduit 134 and dispenser outlet 114, such as within an upper valve seat portion 188 of liquid piston 182 (e.g., an annular flange or protrusion formed on liquid piston 182). Upper valve seat portion 188 may be configured to engage with upper check valve 186 when froth dispenser 101 is in the upward position, thereby blocking flow of fluid past upper check valve 186 (e.g., prevent froth from being dispensed from froth dispenser 101 when actuator 112 is not being depressed). When froth dispenser 101 is in the depressed position, liquid piston 182 may be positioned with respect to upper check valve 186 such that fluid can pass between upper valve seat portion 188 of liquid piston 182 and upper check valve 186, thereby allowing fluid to enter internal passage 132 of actuator 112.

When actuator 112 is actuated (e.g., pressed downward), liquid piston 182 may displace a volume of fluid in liquid conduit 134, forcing the volume of fluid out of liquid conduit 134 and along the fluid path, towards dispenser outlet 114. During actuation, air 104 from air chamber 158 may be mixed with liquid 102 from dispenser reservoir 110 to form a froth. The froth follows the fluid path, flowing past the upper check valve 186 when froth dispenser 101 is in the depressed position, further being forced through aerator chamber 136, into the internal passage 132 of actuator 112, and out through the dispenser outlet 114.

Froth dispenser 101 may include a gasket 190 (e.g., a polyethylene foam gasket) positioned at an interface between upper portion 124 of froth dispenser container 108 and housing 156. A diaphragm 192 also may be included in actuator 112 to permit ambient air 160 from outside the froth dispenser container 108 to enter the front dispenser. At least one chamber aerator 196, 198 (e.g., mesh aerators made of, for example, nylon, one or more polymers, metal, and/or ceramic materials) may be positioned within or adjacent to aerator chamber 136, the aerators being configured to promote frothing of a mixture of air 104 from air chamber 158 and liquid 102 from dispenser reservoir 110. Aerator chamber 136 may be defined by a generally cylindrical, and optionally removable, housing with an aerator positioned at the top and an aerator positioned at the bottom thereof. Additionally or alternatively, aerator chamber 136 may include a first chamber aerator 196 (which may be, for example, a first mesh screen 196) positioned at or near a first chamber end 200, and a second chamber aerator 198 (which may be, for example, second mesh screen 198) positioned at or near a second chamber end 202 opposite first chamber end 200, first and second chamber aerators 196, 198 functioning to aerate any fluid or liquid traveling through aerator chamber 136.

Internal passage 132 of actuator 112 may include a generally axially oriented portion 204, and a generally radially oriented portion 206, with dispenser outlet 114 being a part of generally radially oriented portion 206. In this manner, liquid 102 may follow a generally axially oriented fluid path up through dip stick 116, liquid conduit 134, aerator chamber 136, and into generally axially oriented portion 204 of actuator 112 before changing direction and being forced out of actuator 112 via generally radially oriented portion 206 and dispenser outlet 114.

While FIG. 2 shows a specific example of a froth dispenser 101 according to the present disclosure, such froth dispenser 101 is not meant to be limiting in any way. Many other specific implementations and mechanisms are possible and within the scope of the present disclosure. For example, different types, shapes, and/or numbers of check valves may be utilized in addition to or instead of lower check valve 168 and upper check valve 186. Housing 156 and air chamber 158 may be any suitable size and shape and not limited in any way by the specific example illustrated in FIG. 2. Similarly, the shape of dispenser container 108 shown is exemplary, and may be altered to any size or shape that is functional to hold a volume of liquid. Dispenser container 108 need not be contoured as shown and may instead be, for example, substantially cylindrical in shape, or any other shape. In some examples, froth dispensers 101 may be handheld (e.g., sized and shaped to be grasped in one user's hand) and hand-operated (e.g., may not require the use of batteries or electricity). Disclosed froth dispensers may be too large to be grasped in a single user's hand in some examples, but may be compact enough to be stored in a standard residential refrigerator and/or heated in a standard microwave. Disclosed froth dispensers may be made of microwave safe-materials, and/or materials safe for hot or warm liquids (e.g., disclosed froth dispensers may be formed from materials capable of receiving a boiling liquid within dispenser reservoir 110 in some examples). Dip tube 116 may extend partially into dispenser reservoir 110 as shown, or may extend farther into dispenser reservoir 110, terminating adjacent base 122 of dispenser container 108. It may be appreciated that many such modifications may be implemented in order to froth a liquid in accordance with the present disclosure.

FIGS. 3-4 schematically provide flowcharts that represent illustrative, non-exclusive examples of methods according to the present disclosure. Some steps are illustrated in dashed boxes indicating that such steps may be optional or may correspond to an optional version of a method according to the present disclosure. That said, not all methods according to the present disclosure are required to include the steps illustrated in solid boxes. The methods and steps illustrated in FIGS. 3-4 are not limiting and other methods and steps are within the scope of the present disclosure, including methods having greater than or fewer than the number of steps illustrated, as understood from the discussions herein.

FIG. 3 illustrates a block diagram representing methods of frothing a liquid 300. Methods 300 may include providing a froth dispenser according to the present disclosure at 302 (e.g., froth dispenser 100 of FIG. 1 and/or froth dispenser 101 of FIG. 2), filling at least a portion of the dispenser reservoir (e.g., dispenser reservoir 110 of FIGS. 1-2) with a liquid at 304 (e.g., at least partially filling the dispenser reservoir with one or more of liquid 102, such as a milk product, a milk substitute, cream, a dairy product, egg whites, beer, and alcohol), and actuating an actuator of the froth dispenser at 306 (e.g., hand-actuating actuator 112 of FIGS. 1-2), thereby forming and dispensing a froth from the dispenser outlet at 308 (e.g., dispensing froth 106 of FIG. 1). Dispensing froth at 308 may include dispensing the froth onto and/or into one or more of a beverage, a coffee drink, an alcoholic drink, a dessert, a hot chocolate drink, a cocktail, a cappuccino, vegetables, fruit, and other food items.

Actuating the actuator of the froth dispenser at 306 may include manually pressing a dispenser pump head (e.g., actuator 112 of FIGS. 1-2) downward towards the dispenser reservoir (e.g., dispenser reservoir 110 of FIGS. 1-2). Actuating the actuator of the froth dispenser at 306 may only froth a portion of the liquid in the dispenser reservoir (e.g., the dispensed volume), such that the froth dispenser can be used to top or mix with a plurality of beverages and/or food items with a given volume of liquid, without needing to clean the dispenser or add liquid between every subsequent use. In some methods 300, froth may be dispensed at 308 and then the froth dispenser may be actuated again at 306 in order to again dispense froth at 308. Such a cycle of actuating at 306 and dispensing at 308 may be repeated any number of times, as desired, until the desired quantity of froth has been dispensed into and/or onto one or more beverages and/or food items. The volume of liquid may be replaced or replenished at 304 between subsequent actuations at 306, as desired or needed. Generally, the froth dispenser may be sized to hold a volume of liquid that permits actuating the dispenser at 306 a plurality of times and dispensing a volume of froth at 308 a plurality of times without depleting the volume of liquid held in the froth dispenser. If desired, the froth dispenser also can be shaken before or during actuation, to enhance the frothing action of the dispenser.

The froth dispenser and/or the liquid provided in the froth dispenser may be heated at 310 such that the liquid in the dispenser reservoir is at an elevated temperature when the froth is produced and dispensed. For example, heating at 310 may include heating the liquid before the filling at least a portion of the dispenser reservoir with the liquid. Additionally or alternatively, heating at 310 may include heating the froth dispenser itself before and/or after liquid is provided in the dispenser reservoir. In some examples, the liquid and/or the froth dispenser, together or separate, may be heated (such as in a microwave) before dispensing froth (e.g., the froth dispenser and any liquid inside the froth dispenser may be heated before actuating the froth dispenser at 306 and dispensing froth at 308). In some examples, the liquid may be heated, such as on a stovetop, before being poured into the dispenser reservoir. In other methods, the liquid can be at room temperature, or chilled, at the time of dispensing the froth.

The froth dispenser may be stored at 312 between subsequent uses with at least some liquid remaining in the dispenser reservoir. For example, the froth dispenser may be stored in a refrigerator at 312 when not in use, thereby keeping a liquid in the dispenser reservoir (e.g., milk) fresh and cold. In other examples, the froth dispenser may be stored between uses at 312 in other locations or devices, such as at room temperature (e.g., on a table or counter or shelf in a user's home or office), or in a freezer or warming device. In some methods, at least one packet (e.g., packet 119 of FIG. 1) having one or more packet contents (e.g., packet contents 121 of FIG. 1) may be provided at 314 and added to the liquid and/or the froth dispenser. In some methods, one or more packets may be opened, and the packet contents deposited (e.g., poured, placed, dropped, added to, etc.) into the dispenser reservoir to be mixed with liquid in the dispenser reservoir. In some methods, the packets need not be opened, and may simply be a solid mass that is added to and dissolved in liquid in the dispenser reservoir. Typically, the closure is removed prior to adding packet contents and/or liquid to the dispenser reservoir, thereby providing access to the dispenser reservoir. Packet contents may be added to the liquid before and/or after the liquid is added to the dispenser reservoir. Similarly, packet contents may be added to the froth dispenser before and/or after the liquid is added to the dispenser reservoir. Providing and adding packet contents at 314 may include mixing packet contents with liquid in the dispenser reservoir, such as by stirring, shaking, swirling, mixing, otherwise agitating, and/or allowing time for the packet contents to dissolve and/or diffuse within liquid in the dispenser reservoir. Providing one or more packets at 314, including opening the packet(s), putting the packet contents into the dispenser reservoir, and/or mixing the packet contents with liquid in the dispenser reservoir, may be performed prior to actuating the froth dispenser at 306 and dispensing froth at 308.

Packet contents may include liquid, a powder, a block, one or more capsules, one or more tablets, and/or one or more pellets. Packet contents may be stored in a packet, such as in a pouch (e.g., in the case of liquid or powder packet contents), or in a container or vessel (e.g., in the case of bulk or solid packet contents). In some embodiments, a pouch can be sized to store an individual portion of packet contents, wherein the individual portion of packet contents is sized such that the pouch holds an optimum volume of packet contents for mixing with the volume of liquid held in the dispenser reservoir. For example, a single pouch may be opened and the entire packet contents of the pouch may be emptied into the froth dispenser at 314 and mixed with a liquid in the dispenser reservoir. The liquid may be added before and/or after the packet contents. In this manner, the packet contents may not need to be measured by the user, because a single pouch may be configured to hold an appropriate volume of packet contents for the volume of liquid capable of being held in the froth dispenser reservoir. In some methods, a pouch can be opened (e.g., a portion of a sealed paper or foil pouch can be torn off, exposing an open portion of the pouch, and allowing the packet contents stored in the pouch to be poured out of the pouch and into the dispenser reservoir). Such pouches may be disposable, and disposed of once the packet contents have been removed from the pouch.

In other examples, a container can be provided that houses a volume of packet contents, wherein the volume of packet contents is sufficient to provide a plurality of individual portions of packet contents. In these embodiments, each of the plurality of individual portions of packet contents may be removable from the container one at a time, as needed. For example, in the case of packet contents that are in the form of pellets, a plurality of pellets may be stored in a container, and a desired, predetermined volume of pellets may be scooped out of the container and added to the froth dispenser. In the case of packet contents that are in the form of tablets or capsules, a discrete number of tablets or capsules (e.g., 1 tablet or capsule at a time, or 2 or more tablets or capsules at a time) may be removed from a container housing a plurality of tablets or capsules, and added to the froth dispenser.

Packet contents may be configured to enhance the frothing action of the froth dispenser and/or impart a flavor to a liquid inside the dispenser reservoir of the froth dispenser. Additionally or alternatively, packet contents may include a flavor, a thickening agent, an emulsifier, a masking agent, a gelling agent, a surfactant, and/or a foaming agent, and may be specifically formulated to create a frothy dairy topping when used in combination with the froth dispensers of the present disclosure.

The froth dispenser may be emptied and/or cleaned at 316 when it is desired to change and/or replace or replenish the liquid in the dispenser reservoir, when the volume of liquid in the dispenser reservoir is nearing zero and/or is too low to reach the dip tube, when a user desires a different liquid to be used in the froth dispenser, and/or when the liquid in the dispenser reservoir has aged beyond its useful shelf life and is no longer suitable for frothing onto a beverage or food item. After emptying and/or cleaning, one or more method steps of method 300 may be repeated and the froth dispenser re-used. For example, after emptying and cleaning the froth dispenser at 316, the froth dispenser may again be at least partially filled with a liquid at 304. Furthermore, after actuating at 306 and dispensing froth at 308 one or more times, liquid may again be added to the froth dispenser at 304, such as to replenish the volume of liquid with the same and/or different liquid, without requiring that the froth dispenser be emptied and/or cleaned.

FIG. 4 illustrates a block diagram representing methods 400 that may include selling a froth dispenser (e.g., froth dispenser 100 of FIG. 1 and/or froth dispenser 101 of FIG. 2) according to the present disclosure as a kit, such as by selling the froth dispenser along with instructions, one or more aerators (e.g., aerators 120 of FIGS. 1-2), and/or one or more packets (e.g., packets 119 of FIG. 1). A froth dispenser according to the present disclosure may be provided at 402. Instructions (e.g., instructions 125 of FIG. 1) for using the froth dispenser to froth milk, cream, a milk product, a milk substitute, and/or other dairy products may be provided at 404. Providing instructions for using the froth dispenser at 404 may include providing printed instructions (e.g., written and/or illustrated instructions or tutorials) along with the froth dispenser, displaying information regarding the froth dispenser (e.g., at a retail store where the froth dispenser is sold), providing verbal instructions regarding use of the froth dispenser, and/or providing instructional videos or animations regarding the froth dispenser. Additionally or alternatively, one or more packets as described herein may be provided at 406. According to some methods 400, the froth dispenser may be sold as a kit (e.g., kit 123 of FIG. 1) at 408, where the froth dispenser is sold with at least one packet, at least one aerator (e.g., aerator 120 and/or aerator 127 of FIG. 1), and/or with instructions (e.g., instructions 125 of FIG. 1) to use the froth dispenser to provide a dairy froth topping. In some methods 400, a kit can be sold at 408 as a froth dispenser and instructions for making dairy froth. In some methods 400, a kit can be sold at 408 as a froth dispenser combined with one or more packets. In some methods 400, a kit can be sold at 408 as a froth dispenser combined with instructions for making a dairy froth and one or more packets.

In some methods 400, the froth dispenser may be sold as a kit with a plurality of packets, each of the plurality of packets being the same type of packet in some embodiments, or, in other embodiments, the plurality of packets being an assortment of packets including at least two different types of packets. Additionally or alternatively, at least one packet may be sold separately from the froth dispenser at 410. For example, a plurality of packets may be sold separately from the froth dispenser (whether or not packets are sold with the froth dispenser kit), wherein the plurality of packets is an assortment of packets including at least two different types of packets, or a plurality of the same type of packets. In this manner, once a user has used all the packets that were originally purchased in a kit with a froth dispenser according to the present disclosure and/or purchased separately from the froth dispenser, more packets may be purchased to be used with the froth dispenser in future uses.

Further, one or more aerators (e.g., aerators 120 and/or aerators 127 of FIG. 1) may be provided at 412. Aerators may be provided as replacement aerators to replace lost or damaged aerators that are initially sold with froth dispensers according to the present disclosure, and/or aerators may be provided having various different shapes, sizes, and configurations, such that a plurality of different styles of aerators are available, with different styles of aerators being optimized for different liquids placed in the reservoir. For example, aerators can be provided that are optimized for low-fat liquids, high-fat liquids, dairy liquids, non-dairy liquids, viscous liquids, etc. Aerators may be provided and sold as a kit with the froth dispenser at 408, in addition to or instead of packets and/or instructions. Additionally or alternatively, one or more aerators (e.g., aerators 120 and/or aerators 127 of FIG. 1) may be sold separately from the froth dispenser or kit at 414.

Illustrative, non-exclusive examples of inventive subject matter according to the present disclosure are described in the following enumerated paragraphs:

A1. A froth dispenser, comprising:

a froth dispenser container having a base and an upper portion opposite the base;

a dispenser reservoir configured to receive and hold a liquid, the dispenser reservoir being defined by an inner wall of the froth dispenser container;

an actuator configured, upon actuation of the actuator by depressing the actuator to a depressed position, to cause formation of a froth formed from a mixture of air and the liquid in the dispenser reservoir;

a dispenser outlet, the dispenser outlet configured to provide an opening to allow the froth to exit the froth dispenser;

wherein the froth dispenser defines a fluid path leading from the dispenser reservoir to the dispenser outlet, and wherein the froth dispenser remains in an upward position when the actuator is not being depressed.

A1.1. The froth dispenser of paragraph A1, further comprising a dip tube extending into the dispenser reservoir.

A1.2. The froth dispenser of paragraph A1 or A1.1, further comprising a closure that is removably coupled to the upper portion of the froth dispenser container.

A2. The froth dispenser of any of paragraphs A1-A1.2, wherein the fluid path is defined at least in part by the dispenser reservoir, the dip tube, a liquid conduit, an aerator chamber, and the dispenser outlet.

A3. The froth dispenser of any of paragraphs A1-A2, wherein the froth dispenser is specifically configured to form a dairy froth.

A4. The froth dispenser of any of paragraphs A1-A3, wherein the actuator is a pump head having an upper convex portion that is curved and configured to increase comfort during actuation.

A5. The froth dispenser of any of paragraphs A1-A4, wherein the dispenser outlet is a downward facing opening formed integrally with the actuator.

A6. The froth dispenser of any of paragraphs A1-A5, wherein the actuator includes an outlet aerator positioned adjacent the dispenser outlet.

A7. The froth dispenser of any of paragraphs A1-A6, wherein the actuator includes an outlet aerator positioned adjacent the dispenser outlet, and further wherein the actuator includes a hinge adjacent the dispenser outlet, wherein the hinge allows a hinged portion of the dispenser outlet to move from a first position wherein the hinged portion is in contact with the actuator to a second position wherein the hinged portion is flipped up, away from the actuator.

A8. The froth dispenser of paragraph A7, wherein, in the first position, the outlet aerator is in the fluid path of the froth exiting the dispenser outlet, and in the second position, the outlet aerator is not in the fluid path of the froth exiting the dispenser outlet.

A9. The froth dispenser of any of paragraphs A1-A8, further comprising a foamable liquid contained in the dispenser reservoir, wherein the foamable liquid contained in the dispenser reservoir is one or more of milk, cream, creamer, half and half, low-fat milk, whole milk, skim milk, 2% milk, egg whites, alcohol, beer, goat's milk, soy milk, rice milk, almond milk, hemp milk, coconut milk, a milk substitute, condensed milk, powdered milk, water, yogurt, cream fraiche, reconstituted powdered milk, evaporated milk, and reconstituted evaporated milk.

A10. The froth dispenser of any of paragraphs A1-A9, further comprising a reservoir mesh aerator positioned within the dispenser reservoir.

A11. The froth dispenser of paragraph A10, wherein the reservoir mesh aerator is oriented substantially parallel to the base of the froth dispenser container.

A12. The froth dispenser of paragraph A11, wherein the reservoir mesh aerator extends radially from the dip tube towards the inner wall of the froth dispenser container.

A13. The froth dispenser of paragraph A12, wherein the reservoir mesh aerator extends only part of a radial distance from the dip tube to the inner wall, thereby leaving a gap between a circumferential edge of the reservoir mesh aerator and the inner wall of the froth dispenser container.

A14. The froth dispenser of paragraph A12, wherein the reservoir mesh aerator extends radially from the dip tube all the way to the inner wall of the froth dispenser container, and wherein a circumferential edge of the reservoir mesh aerator contacts the inner wall of the froth dispenser container.

A15. The froth dispenser of paragraph A14, wherein the circumferential edge of the reservoir mesh aerator forms a gasket-like seal with the inner wall of the froth dispenser container.

A16. The froth dispenser of any of paragraphs A13-A15, wherein the circumferential edge of the reservoir mesh aerator is flexible.

A17. The froth dispenser of any of paragraphs A1-A16, wherein the froth dispenser container is contoured, such that a middle portion has a larger diameter than the base or the upper portion.

A18. The froth dispenser of any of paragraphs A10-A17, wherein at least a portion of the reservoir mesh aerator is flexible to facilitate insertion and removal of the reservoir mesh aerator through the upper portion of the froth dispenser container.

A19. The froth dispenser of any of paragraphs A1-A18, wherein the froth dispenser is configured to be used a plurality of times.

A20. The froth dispenser of any of paragraphs A1-A19, wherein the froth dispenser is configured to be used a plurality of times without needing to be cleaned between uses.

A21. The froth dispenser of any of paragraphs A1-A20, wherein the froth dispenser is configured to be used a plurality of times without changing the liquid in the dispenser reservoir.

A22. The froth dispenser of any of paragraphs A1-A21, wherein the froth dispenser is configurable between a first configuration and a second configuration.

A23. The froth dispenser of paragraph A22, wherein the first configuration corresponds to the froth dispenser being optimized for a first liquid in the dispenser reservoir, and the second configuration corresponds to the froth dispenser being optimized for a second liquid in the dispenser reservoir, the first liquid being different from the second liquid.

A24. The froth dispenser of paragraph A23, wherein the first liquid is one of skim milk, low-fat milk, 2% milk, whole milk, and cream, and the second liquid is another of skim milk, low-fat milk, 2% milk, whole milk, and cream.

A25. The froth dispenser of any of paragraphs A1-A24, wherein the froth dispenser container is flexible.

A26. The froth dispenser of any of paragraphs A1-A25, wherein the froth dispenser includes a plurality of aerators.

A27. The froth dispenser of any of paragraphs A1-A26, further comprising a housing positioned inside the froth dispenser container.

A28. The froth dispenser of paragraph A27, wherein the housing defines an air chamber configured to hold a volume of air.

A29. The froth dispenser of paragraph A28, wherein the air chamber is in fluid communication with ambient air outside of the froth dispenser when the froth dispenser is in the depressed position.

A30. The froth dispenser of paragraph A28 or A29, wherein the air chamber is not in fluid communication with ambient air outside of the froth dispenser when the froth dispenser is in the upward position.

A31. The froth dispenser of any of paragraphs A28-A30, wherein the housing comprises a side vent opening that allows passage of air into the air chamber.

A32. The froth dispenser of paragraph A31, wherein the froth dispenser comprises an air piston having an air chamber scraper, and wherein when the froth dispenser is in the upward position, the air chamber scraper covers the side vent opening so that ambient air cannot pass into the air chamber.

A33. The froth dispenser of paragraph A32, wherein when the actuator is actuated and the froth dispenser is in the depressed position, the air piston is moved downward towards the base of the froth dispenser container such that the air chamber scraper does not cover the side vent opening, thereby allowing passage of ambient air from outside the froth dispenser into the air chamber.

A34. The froth dispenser of any of paragraphs A2-A33, wherein the dip tube is in liquid communication with the liquid conduit while the froth dispenser is in at least one of the depressed position and the upward position.

A35. The froth dispenser of any of paragraphs A2-A34, further comprising a lower check valve positioned within a lower valve seat, wherein the lower valve seat is formed by an interface between the liquid conduit and the dip tube.

A36. The froth dispenser of any of paragraphs A2-A35, further comprising a spring positioned within the liquid conduit.

A37. The froth dispenser of paragraph A36 when depending from A35, wherein, in the depressed position, the spring forces the lower check valve into the lower valve seat, thereby blocking passage of liquid from the dip tube into the liquid conduit.

A38. The froth dispenser of any of paragraphs A36-A37, wherein, in the upward position, a force applied by the spring on the lower check valve is low enough that liquid can pass from the dip tube, through the lower valve seat, and into the liquid conduit.

A39. The froth dispenser of any of paragraphs A36-A38, wherein the spring comprises stainless steel.

A40. The froth dispenser of any of paragraphs A35-A39, wherein the lower check valve comprises a glass ball.

A41. The froth dispenser of any of paragraphs A36-A40, wherein the froth dispenser further comprises a spring stem positioned within the spring.

A42. The froth dispenser of any of paragraphs A1-A41, further comprising a pull stick.

A43. The froth dispenser of paragraph A42 when depending from A41, wherein the pull stick comprises an enlarged portion configured to engage with the spring stem, and a narrow portion positioned within the liquid conduit.

A44. The froth dispenser of any of paragraphs A2-A43, further comprising a liquid piston slidably engaged with an interior wall of the liquid conduit.

A45. The froth dispenser of any of paragraphs A2-A44, wherein the froth dispenser further comprises an upper check valve positioned within the fluid path between the liquid conduit and the dispenser outlet.

A46. The froth dispenser of paragraph A45 when depending from A44, wherein the liquid piston comprises an upper valve seat portion that engages with the upper check valve when the froth dispenser is in the upward position, thereby blocking flow of fluid past the upper check valve.

A47. The froth dispenser of any of paragraphs A45-A46, wherein when the froth dispenser is in the depressed position, the liquid piston is positioned with respect to the upper check valve such that fluid can pass between the upper valve seat portion of the liquid piston and the upper check valve.

A48. The froth dispenser of any of paragraphs A44-A47, wherein, when the actuator is actuated, the liquid piston displaces a volume of fluid in the liquid conduit, forcing the volume of fluid out of the liquid conduit and along the fluid path, towards the dispenser outlet.

A49. The froth dispenser of any of paragraphs A28-A48, wherein the froth dispenser is configured such that air from the air chamber is mixed with liquid from the dispenser reservoir.

A50. The froth dispenser of any of paragraphs A27-A49, further comprising a gasket positioned at a second interface between the upper portion of the froth dispenser container and the housing.

A51. The froth dispenser of paragraph A50, wherein the gasket comprises polyethylene foam.

A52. The froth dispenser of any of paragraphs A50-A51, wherein the gasket permits ambient air from outside the froth dispenser container to enter the froth dispenser container.

A53. The froth dispenser of any of paragraphs A1-A52, further comprising a diaphragm.

A54. The froth dispenser of any of paragraphs A2-A53, further comprising at least one chamber aerator positioned within the aerator chamber, the chamber aerator being configured to promote foaming of a mixture of air from the air chamber and liquid from the dispenser reservoir.

A55. The froth dispenser of paragraph A54, wherein the chamber aerator comprises nylon mesh.

A56. The froth dispenser of any of paragraphs A2-A55, further comprising at least one actuator aerator positioned within the actuator, the actuator aerator being positioned at least partially outside of the aerator chamber.

A57. The froth dispenser of any of paragraphs A2-A56, wherein the aerator chamber comprises a first mesh screen at a first chamber end, and a second mesh screen at a second chamber end opposite the first chamber end.

A58. The froth dispenser of any of paragraphs A1.2-A57, wherein the actuator is slidably engaged with the closure such that ambient air from outside the froth dispenser can pass between the actuator and the closure.

A59. The froth dispenser of any of paragraphs A1-A58, wherein the actuator comprises an internal passage, a portion of the internal passage being generally axially oriented, and a second portion of the internal passage being generally radially oriented, and wherein the dispenser outlet is formed from the second portion of the internal passage of the actuator.

B1. A method of frothing a liquid, comprising:

providing a froth dispenser according to any of paragraphs A1-A59; filling at least a portion of the dispenser reservoir with a liquid; and

hand-actuating the actuator of the froth dispenser, thereby dispensing froth from the dispenser outlet.

B2. The method of paragraph B1, wherein the filling at least a portion of the dispenser reservoir with a liquid comprises filling at least a portion of the dispenser reservoir with one or more of a milk product, a milk substitute, cream, a dairy product, egg whites, and beer.

B3. The method of paragraph B1 or B2, further comprising dispensing froth from the froth dispenser onto one or more of a beverage, a coffee drink, an alcoholic drink, a dessert, a hot chocolate drink, a cocktail, a cappuccino, vegetables, fruit, and other food.

B4. The method of any of paragraphs B1-B3, further comprising heating the froth dispenser, thereby heating the liquid in the dispenser reservoir.

B5. The method of any of paragraphs B1-B4; further comprising heating the liquid before the filling at least a portion of the dispenser reservoir with the liquid.

B6. The method of any of paragraphs B1-B5, wherein hand-actuating the actuator of the froth dispenser comprises manually pressing a dispenser head downward towards the dispenser reservoir.

B7. The method of any of paragraphs B1-B6, further comprising storing the froth dispenser between subsequent uses with at least some liquid in the dispenser reservoir.

B8. The method of any of paragraphs B1-B7, further comprising storing the froth dispenser in a refrigerator when not in use.

B9. The method of any of paragraphs B1-B8, wherein hand-actuating the actuator of the froth dispenser only froths a portion of the liquid in the dispenser reservoir.

B10. The method of any of paragraphs B1-B9, further comprising shaking the froth dispenser.

B11. The method of any of paragraphs B1-B10, further comprising providing at least one packet having one or more packet contents.

B12. The method of paragraph B11, further comprising opening the packet.

B13. The method of paragraphs B11 or B12, further comprising putting the packet contents in the dispenser reservoir.

B14. The method of any of paragraphs B11-B13, further comprising removing the closure to provide access to the dispenser reservoir.

B15. The method of any of paragraphs B11-B14, further comprising pouring the packet contents into the dispenser reservoir.

B16. The method of any of paragraphs B13-B15, wherein the putting the packet contents in the dispenser reservoir and/or the pouring the packet contents into the dispenser reservoir are performed before the filling at least a portion of the dispenser reservoir with the liquid.

B17. The method of any of paragraphs B11-B16, further comprising mixing the packet contents with the liquid in the dispenser reservoir.

B18. The method of any of paragraphs B11-B17, wherein the packet contents include one or more of a powder, a liquid, a block, one or more capsules, one or more tablets, and one or more pellets.

B19. The method of any of paragraphs B11-B18, further comprising dissolving the packet contents in the liquid in the dispenser reservoir.

B20. The method of any of paragraphs B4-B19, wherein heating the froth dispenser includes microwaving the froth dispenser.

C1. A packet for use with a froth dispenser of any of paragraphs A1-A59, comprising:

packet contents; and

a container for storing the packet contents.

C2. The packet of paragraph C1, wherein the packet contents are configured to enhance the frothing action of the froth dispenser.

C3. The packet of paragraph C1 or C2, wherein the packet contents are configured to impart a flavor to a liquid inside the dispenser reservoir of the froth dispenser.

C4. The packet of any of paragraphs C1-C3, wherein the packet contents comprise at least one of a liquid, a powder, a block, one or more capsules, one or more tablets, and one or more pellets.

C5. The packet of any of paragraphs C1-C4, wherein the packet contents comprise a surfactant.

C6. The packet of any of paragraphs C1-C5, wherein the packet contents comprise a foaming agent.

C7. The packet of any of paragraphs C1-C6, wherein the packet contents are specifically formulated to create a frothy dairy topping when used in combination with the froth dispenser of any of paragraphs A1-A59.

C8. The packet of any of paragraphs C1-C7, wherein the container for storing the packet contents comprises a pouch sized to store an individual portion of packet contents, wherein the individual portion of packet contents is sized such that the pouch holds an optimum volume of packet contents for mixing with the volume of liquid held in the dispenser reservoir.

C9. The packet of paragraph C8, wherein the pouch is configured to be openable, and wherein the packet contents can be poured into the reservoir of the froth dispenser once the pouch is opened.

C10. The packet of paragraph C8 or C9, wherein the pouch is disposable.

C11. The packet of any of paragraphs C1-C10, wherein the packet contents are dissolvable in a liquid in the reservoir of the froth dispenser.

C12. The packet of any of paragraphs C1-C11, wherein the container for storing the packet contents comprises a container housing a volume of packet contents, wherein the volume of packet contents is sufficient to provide a plurality of individual portions of packet contents, and wherein each of the plurality of individual portions of packet contents is removable from the container one at a time.

D1. A method, comprising:

selling a froth dispenser according to any of paragraphs A1-A59; and

providing instructions for using the froth dispenser to froth at least one of: milk, cream, creamer, half and half, low-fat milk, whole milk, skim milk, 2% milk, egg whites, alcohol, beer, goat's milk, soy milk, rice milk, almond milk, hemp milk, coconut milk, a milk substitute, condensed milk, powdered milk, water, yogurt, cream fraiche, reconstituted powdered milk, evaporated milk, and reconstituted evaporated milk.

D2. The method of paragraph D1, wherein the selling of a froth dispenser comprises selling a froth dispenser as a kit including at least one packet according to any of paragraphs C1-C12.

D3. The method of paragraph D1 or D2, wherein the selling of a froth dispenser comprises selling a froth dispenser as a kit with a plurality of packets according to any of paragraphs C1-C12.

D4. The method of paragraph D3, wherein selling a froth dispenser as a kit with a plurality of packets comprises selling a froth dispenser as a kit with a plurality of packets each being the same type of packet.

D5. The method of paragraph D3, wherein selling a froth dispenser as a kit with a plurality of packets comprises selling a froth dispenser as a kit with at least two different types of packets.

D6. The method of any of paragraphs D1-D5, further comprising selling at least one packet according to any of paragraphs C1-C12, separately from the froth dispenser.

D7. The method of any of paragraphs D1-D6, further comprising selling a plurality of packets according to any of paragraphs C1-C12, separately from the froth dispenser, wherein the plurality of packets is an assortment of packets including at least two different types of packets.

E1. A kit, comprising:

a froth dispenser according to any of paragraphs A1-A59; and

at least one packet according to any of paragraphs C1-C12.

E2. The kit of paragraph E1, further comprising an aerator that is configured to be used with the froth dispenser.

E3. The kit of any of paragraphs E1-E2, further comprising written instructions for using the froth dispenser to froth at least one of: milk, cream, creamer, half and half, low-fat milk, whole milk, skim milk, 2% milk, egg whites, alcohol, beer, goat's milk, soy milk, rice milk, almond milk, hemp milk, coconut milk, a milk substitute, condensed milk, powdered milk, water, yogurt, cream fraiche, reconstituted powdered milk, evaporated milk, and reconstituted evaporated milk.

E4. The kit of any of paragraphs E1-E3, further comprising illustrated instructions for using the froth dispenser to froth at least one of: milk, cream, creamer, half and half, low-fat milk, whole milk, skim milk, 2% milk, egg whites, alcohol, beer, goat's milk, soy milk, rice milk, almond milk, hemp milk, coconut milk, a milk substitute, condensed milk, powdered milk, water, yogurt, cream fraiche, reconstituted powdered milk, evaporated milk, and reconstituted evaporated milk.

E5. The kit of any of paragraphs E1-E4, further comprising written instructions instructing a user to perform one or more of the steps of the method of any of paragraphs B1-B20.

E6. The kit of any of paragraphs E1-E5, further comprising illustrated instructions showing a user how to perform one or more of the steps of the method of any of paragraphs B1-B20.

F1. A kit, comprising:

a froth dispenser according to any of paragraphs A1-A59; and

at least one aerator configured to be used with the froth dispenser.

F2. The kit of paragraph F1, further comprising written instructions for using the froth dispenser to froth at least one of: milk, cream, creamer, half and half, low-fat milk, whole milk, skim milk, 2% milk, egg whites, alcohol, beer, goat's milk, soy milk, rice milk, almond milk, hemp milk, coconut milk, a milk substitute, condensed milk, powdered milk, water, yogurt, cream fraiche, reconstituted powdered milk, evaporated milk, and reconstituted evaporated milk.

F3. The kit of any of paragraphs F1-F2, further comprising illustrated instructions for using the froth dispenser to froth at least one of: milk, cream, creamer, half and half, low-fat milk, whole milk, skim milk, 2% milk, egg whites, alcohol, beer, goat's milk, soy milk, rice milk, almond milk, hemp milk, coconut milk, a milk substitute, condensed milk, powdered milk, water, yogurt, cream fraiche, reconstituted powdered milk, evaporated milk, and reconstituted evaporated milk.

F4. The kit of any of paragraphs F1-F3, further comprising written instructions instructing a user to perform one or more of the steps of the method of any of paragraphs B1-B20.

F5. The kit of any of paragraphs F1-F4, further comprising illustrated instructions showing a user how to perform one or more of the steps of the method of any of paragraphs B1-B20.

As used herein, the terms “selective” and “selectively,” when modifying an action, movement, configuration, or other activity of one or more components or characteristics of an apparatus, mean that the specific action, movement, configuration, or other activity is a direct or indirect result of user manipulation of an aspect of, or one or more components of, the apparatus.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. A froth dispenser, comprising:
a froth dispenser container having a base and an upper portion opposite the base;
a dispenser reservoir configured to receive and hold a liquid, the dispenser reservoir being defined by an inner wall of the froth dispenser container;
an actuator configured, upon actuation of the actuator by depressing the actuator to a depressed position, to cause formation of a froth formed from a mixture of air and the liquid in the dispenser reservoir;
a dispenser outlet configured to provide an opening to allow the froth to exit the froth dispenser, the froth dispenser being configured such that the froth is forced out of the dispenser outlet when the actuator is actuated;
wherein the froth dispenser defines a fluid path leading from the dispenser reservoir to the dispenser outlet, wherein the froth dispenser remains in an upward position when the actuator is not being depressed, and wherein the froth dispenser is specifically configured to form a dairy froth.

2. The froth dispenser according to claim 1, wherein the actuator includes an outlet aerator positioned adjacent the dispenser outlet.

3. The froth dispenser according to claim 1, further comprising a plurality of aerators, at least a first aerator of the plurality of aerators being positioned within the dispenser reservoir and coupled to a dip tube, the dip tube being configured to transfer liquid from the dispenser reservoir towards the dispenser outlet, and at least a second aerator of the plurality of aerators being positioned within the actuator.

4. The froth dispenser according to claim 3, further comprising a foamable liquid contained in the dispenser reservoir, wherein the foamable liquid contained in the dispenser reservoir is one or more of milk, cream, creamer, half and half, low-fat milk, whole milk, skim milk, 2% milk, egg whites, alcohol, beer, goat's milk, soy milk, rice milk, almond milk, hemp milk, coconut milk, a milk substitute, condensed milk, powdered milk, yogurt, cream fraiche, reconstituted powdered milk, evaporated milk, and reconstituted evaporated milk.

5. The froth dispenser according to claim 4, wherein the first aerator extends radially from the dip tube towards the inner wall of the froth dispenser container.

6. The froth dispenser according to claim 5, wherein a circumferential edge of the first aerator forms a gasket-like seal with the inner wall of the froth dispenser container.

7. The froth dispenser according to claim 4, wherein the froth dispenser is configured such that a single actuation of the actuator causes the froth to exit the froth dispenser via the dispenser outlet.

8. A method of frothing a liquid, comprising:
providing the froth dispenser according to claim 1;
filling at least a portion of the dispenser reservoir with a liquid, wherein the liquid comprises one or more of a milk product, a milk substitute, cream, and a dairy product; and
hand-actuating the actuator of the froth dispenser, thereby dispensing froth from the dispenser outlet.

9. The method according to claim 8, further comprising dispensing froth from the froth dispenser onto one or more of a beverage or a food product.

10. The method according to claim 8, further comprising, prior to the hand-actuating, heating the froth dispenser, thereby heating the liquid in the dispenser reservoir.

11. The method according to claim 8, wherein the hand-actuating the actuator of the froth dispenser comprises manually pressing a dispenser head downward towards the dispenser reservoir.

12. The method according to claim 11, wherein the hand-actuating the actuator comprises hand-actuating the actuator a single time.

13. The method according to claim 8, further comprising storing the froth dispenser between subsequent uses with at least some of the liquid remaining in the dispenser reservoir.

14. The method according to claim 8, wherein the hand-actuating the actuator of the froth dispenser only froths a portion of the liquid in the dispenser reservoir.

15. The method according to claim 8, further comprising providing at least one packet having one or more packet contents, opening the packet, putting the packet contents into the dispenser reservoir, and mixing the packet contents with the liquid in the dispenser reservoir prior to the hand-actuating.

16. The method according to claim 15, wherein the packet contents include one or more of a thickening agent, a flavoring, a foaming agent, a powder, a liquid, a block, one or more capsules, one or more tablets, and one or more pellets.

17. A method, comprising:
selling a froth dispenser according to claim 1; and
providing instructions for using the froth dispenser to froth at least one of: milk, cream, a milk product, a milk substitute, and other dairy products, wherein the instructions instruct a user to perform one or more of filling at least a portion of the dispenser reservoir with a dairy product, hand-actuating the actuator of the froth dispenser, thereby dispensing froth from the dispenser, dispensing froth from the froth dispenser onto one or more of a beverage or a food product, heating the froth dispenser, storing the froth dispenser between subsequent uses with at least some of the liquid remaining in the dispenser reservoir, opening a packet containing packet contents, putting the packet contents into the dispenser reservoir, and mixing the packet contents with the dairy product in the dispenser.

18. The method according to claim 17, wherein the selling the froth dispenser comprises selling the froth dispenser as a kit including the packet, the packet being configured to be opened and the packet contents being configured to be removed from the packet, placed into the dispenser reservoir, and mixed with the liquid, wherein the packet contents include one or more of a thickening agent, a flavoring, a foaming agent, a powder, a liquid, a block, one or more capsules, one or more tablets, and one or more pellets.

19. A kit, comprising:
the froth dispenser according to claim 1; and
at least one packet containing packet contents, the packet being configured to be opened and the packet contents being configured to be removed from the packet, placed into the dispenser reservoir, and mixed with the liquid, wherein the packet contents include one or more of a thickening agent, a flavoring, a foaming agent, a powder, a liquid, a block, one or more capsules, one or more tablets, and one or more pellets.

20. The kit according to claim 19, further comprising an aerator that is configured to be selectively used with the froth dispenser.
